(19) United States
(12) Patent Application Publication
(10) Pub. No.: US 2002/0072038 A1
(43) Pub. Date: Jun. 13, 2002

(54) Method of making problems for people to learn a foreign language through sentence practice and the system for the same

(76) Inventors: Sayling Wen, Taipei (TW); Zechary Chang, Taipei (TW); Pinky Ma, Beijing (CN)

Correspondence Address: BIRCH STEWART KOLASCH & BIRCH, PO BOX 747, FALLS CHURCH, VA, 22040-0747, US

(21) Appl. No.: 09/859,589

(22) Filed: May 18, 2001

(30) Foreign Application Priority Data
Dec. 8, 2000 (TW) 89126290

(51) Int. Cl. G09B 19/06

(52) U.S. Cl. 434/157

(57) ABSTRACT

A method for making problems for people learning a foreign language through sentence practice. The method includes a problem style determination procedure, a sentence pattern reading in procedure, a sentence pattern partition procedure, a sentence pattern recombination procedure, a problem output procedure, an input accepting procedure, a comparison procedure, and a result output procedure. The problem style determination procedure determines a problem style. The sentence pattern reading in procedure reads in a prototype sentence pattern from a computer readable sentence pattern database. The sentence partition procedure separates the prototype sentence pattern into a plurality of sentence pattern components. The sentence pattern recombination procedure shuffles the sentence pattern components to obtain a recombined sentence pattern. The problem output procedure outputs the recombined sentence pattern to a learner according to the problem style. The input accepting procedure receives input from the learner. The comparison procedure compares the prototype sentence pattern with the learner's input using a comparison module to obtain a comparison result. The result output procedure outputs the comparison result to the learner.

### BACKGROUND OF THE INVENTION

1. Field of Invention

The invention relates to a method of learning a foreign language and the system for the same. In particular, the invention relates to a method of creating problems for people to assist in learning a foreign language through sentence practice and the system for the same.

2. Related Art

Making sentences is a necessary type of practice for language training during the process of learning a foreign language. Normal sentence practice classes are done by taking a limited number of typical sentence patterns given by the teacher and performing reproductions and substitutions. Such sentence making activities focuses on learning the sentence structure without emphasizing the familiarity with some sentence components and their applications. Moreover, this kind of training does not help students think in the foreign language. Through such training, the students can only master the general structure of sentence transformation, but are not able to have a detailed understanding about what kind of transformation and word attributes should be used. In actual social activities, learners who take such an approach usually cannot compose a sentence that is appropriate and abides by grammatical rules.

In recent years, along with the development of computer technologies many companies have made foreign language learning materials using the computer as a tool. Nevertheless, most of them merely provide a huge amount of content or test problems for learners to practice over and over again. They do not actually improve the teaching method by utilizing some computer features. In other words, they do not fully utilize the high interactivity between the computer and the learner and the convenience of using a computer for studying. Therefore, the prior art cannot perform integrated practice by making problems with increasing difficulties for the learner to master in a foreign language.

Therefore, how to apply mature computer technologies to making problems with increasing difficulties in steady steps so as to perform more efficient foreign language teaching and to increase the learner's language ability is indeed an important subject.

### SUMMARY OF THE INVENTION

In view of the foregoing problems, it is an objective of the invention to provide a method of making problems with increasing difficulties for people learning a foreign language through sentence practice in steady steps and the corresponding system. It provides a sentence practice environment that starts easy moves on to the difficult to allow learners to steadily increase their foreign language ability.

To achieve the above objective, the disclosed method includes a problem style determination procedure, a sentence pattern reading in procedure, a sentence pattern partition procedure, a sentence pattern recombination procedure, a problem output procedure, an input accepting procedure, a comparison procedure, and a result output procedure. The problem style determination procedure determines a problem style. The sentence pattern reading procedure reads in a prototype sentence pattern from a computer readable sentence pattern database. The sentence partition procedure separates the prototype sentence pattern into a plurality of sentence pattern components. The sentence pattern recombination procedure shuffles the sentence pattern components to obtain a recombined sentence pattern. The problem output procedure outputs the recombined sentence pattern to a learner according to the problem style. The input accepting procedure receives input from the learner. The comparison procedure compares the prototype sentence pattern with the learner's input using a comparison module to obtain a comparison result. The result output procedure outputs the comparison result to the learner.

The invention also discloses a system that includes a sentence pattern database, a sentence pattern partition module, a sentence pattern recombination module, a problem output module, an input accepting module, a comparison module, and a result output module. The sentence pattern database stores a plurality of sentence pattern data structures, each of which contains a prototype sentence pattern. The sentence partition module separates the prototype sentence pattern into a plurality of sentence pattern components. The sentence pattern recombination module shuffles the sentence pattern components to obtain a recombined sentence pattern. The problem output module outputs the recombined sentence pattern to a learner according to a problem style entered by the learner. The input accepting module receives input from the learner. The comparison module compares the prototype sentence pattern with the learner's input using a comparison module to obtain a comparison result. The result output module outputs the comparison result to the learner.

Using the disclosed method and system can fully utilize computer or network technologies to implement various types of problem styles, making foreign language teaching more efficient.

Using the disclosed method and system can fully utilize computer or network technologies to provide learners a basic sentence practice environment for learners to experience a simulated real conversion, establishing a whole new sentence practice training model.

According to the disclosed method and system, a learner first obtains a sentence practice objective. In accordance with different requirements in the sentence practice training procedure, the learner completes such operations as sentence component selection, combination, and transformation under the monitoring of the system. Through such monitoring, the system helps the learner achieve the goal of making a complete sentence. By repetitious practice, the system can strengthen the learner's experience in building sentences. Eventually, this kind of experience will become intuitive and the learner will have the ability to build correct sentences.

Other features and advantages of the invention will be apparent from the following detailed description, which proceeds with reference to the accompanying drawings.

### BRIEF DESCRIPTION OF THE DRAWINGS

The invention will become more fully understood from the detailed description given in the hereinbelow illustration only, and thus do not limit the invention, and wherein:

FIG. 1 is a flowchart showing the procedure of the method of making problems with increasing difficulties for people learning a foreign language through sentence practice in steady steps according to a preferred embodiment of the invention;

FIG. 2 is a schematic view of the contents of the sentence pattern data structure used in the method in FIG. 1;

FIG. 3 is a schematic view of the correspondence between the sentence pattern component table, the interference element table, the phrase partition table, the prototype derivative table, and the attribute derivative table according to the method in FIG. 1;

FIGS. 4(A) through 4(H) are schematic views showing the situations for various problem styles according to the method in FIG. 1; and

FIG. 5 is a schematic view showing the structure of the system of making problems with increasing difficulties for people learning a foreign language through sentence practice in steady steps according to a preferred embodiment of the invention.

### DETAILED DESCRIPTION OF THE INVENTION

The disclosed method and system will be apparent from the following detailed description, which proceeds with reference to the accompanying drawings, wherein the same references relate to the same elements.

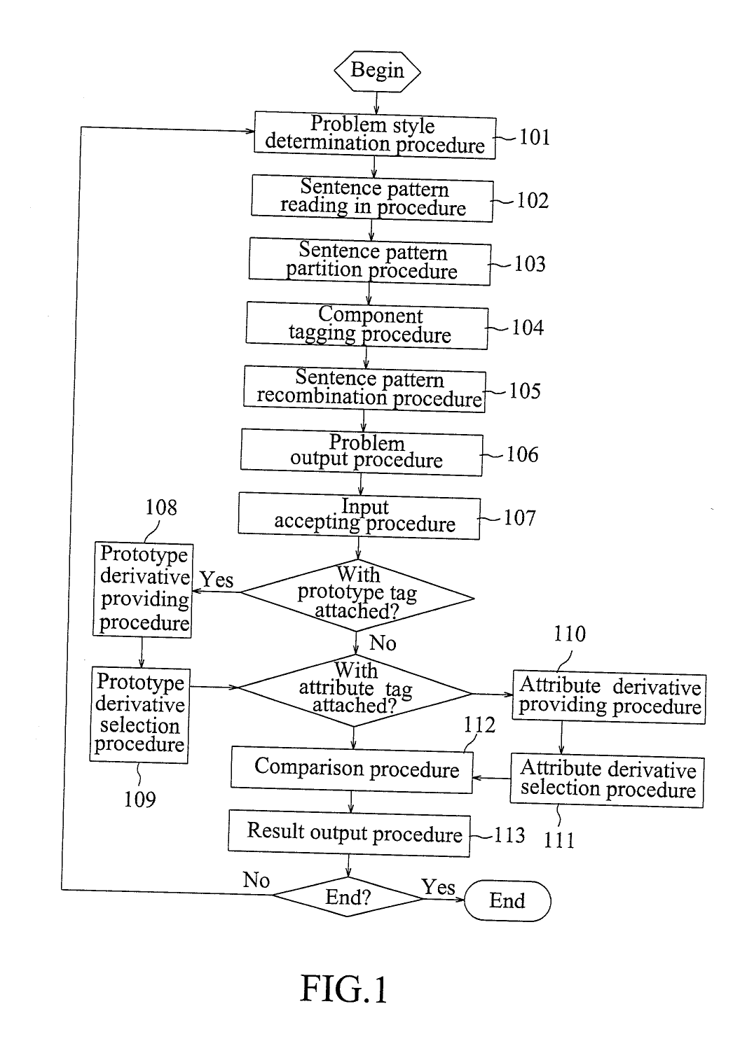

Referring to FIG. 1, the method 1 of making sentences for people learning a foreign language according to a preferred embodiment of the invention first process a problem style determination procedure 101 to determine what problem style to use. In the current embodiment, there are eight types of problem styles, including phrase sentence practice, word sentence practice, advanced phrase sentence practice, advanced word sentence practice, prototype sentence practice, advanced prototype sentence practice, ultimate sentence practice, and advanced ultimate sentence practice. Each type has a different characteristic and difficulty, which will be further explained hereinafter.

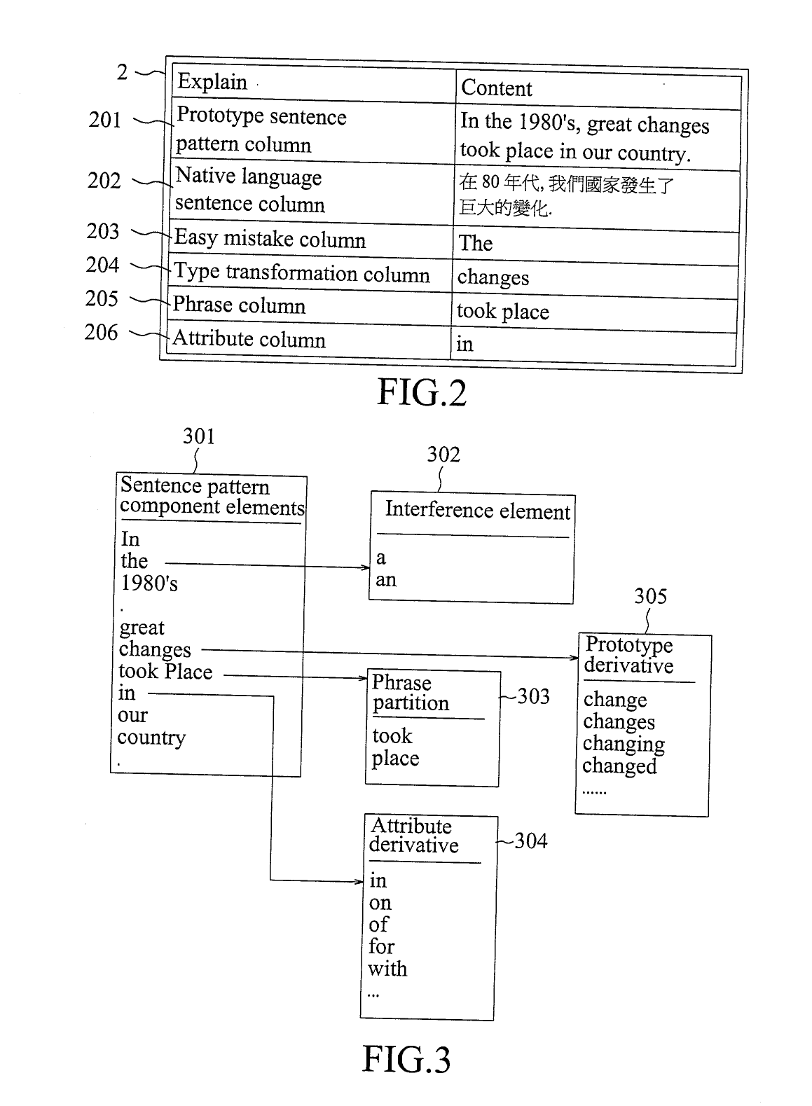

A sentence pattern reading in procedure 102 is then processed to read in a prototype sentence pattern from a computer readable sentence pattern database. With reference to FIG. 2, the database stores the prototype sentence pattern data structure 204, which includes a prototype sentence pattern column 201, a native language sentence column 202, an easy mistake column 203, a type transformation column 204, a phrase column 205, and a word attribute column 206. In the prototype sentence pattern data structure 2, the prototype sentence pattern is stored in the prototype sentence pattern column 201, e.g., “In the 1980's, great changes took place in our country.” The corresponding native language sentence is stored in the native language sentence column 202.

The easy mistake column 203 stores words that are easily misused in the above prototype sentence pattern. For example, “the” is often mixed with the indefinite article “a” and “an”, they are in the list of the easy mistake column 203. The type transformation column 204 stores words with various type transformations in the prototype sentence pattern. For example, “changes” in the above prototype sentence pattern has the original type “change”, the past type “changed”, and the progressive type “changing”, etc. Therefore, they are listed in the type transformation column 204. The phrase 205 stores the phrases appearing in the prototype sentence pattern, such as “took place.” The word attribute column 206 stores words that have the same attributes and are easily mixed with the words in the prototype sentence pattern. For example, the preposition “in” is often mixed with other propositions “on” and “of” in use, therefore, they are listed in the word attribute column 206.

In the sentence pattern partition procedure 103, the prototype sentence pattern is separated into several sentence pattern components. Referring to FIG. 3, the ones shown in the sentence pattern component table 301 are the result after separating the prototype sentence pattern into its components. In the sentence pattern component table 301, except the phrase “took place” in the phrase column 205, which is considered as one component, all words including punctuations such as commas and periods are considered as individual sentence pattern components. Thus, the prototype sentence pattern stored in the prototype sentence pattern column 201 has eleven sentence pattern components.

If the problem styles are word sentence practice, advanced word sentence practice, prototype sentence practice, advanced prototype sentence practice, ultimate sentence practice, or advanced ultimate sentence practice, then the phrase has to be further separated into words in the sentence pattern partition procedure 103. For example, in FIG. 3, the phrase partition table 303 further separates the phrase “took place” in the sentence pattern component table 301 into two sentence pattern components “took” and “place”. Therefore, the prototype sentence pattern is decomposed into 12 sentence pattern components.

If the problem style is prototype sentence practice or advanced prototype sentence practice, then the words recorded in the type transformation column 204 are converted into their prototypes. Using a prototype derivative table 305 shown in FIG. 3, the prototype derivatives are provided to the learner. If the problem style is ultimate sentence practice or advanced ultimate sentence practice, the attribute derivatives of the words in the word attribute column 206 are provided to the user according to their attributes and an attribute derivative table 304. The procedure of providing prototype derivatives and attribute derivatives will be described in detail hereinafter.

Afterwards, a component tagging procedure 104 tags each sentence pattern component according to the problem style determined in the problem style determination procedure 101. For example, if the problem style is the word sentence practice, then each sentence pattern component is attached with a normal tag. If the problem style is the prototype sentence practice, then only some specific sentence pattern components are attached with prototype tags. If the problem style is the ultimate sentence practice, then some specific sentence pattern components are attached with attribute tags. In the sentence recombination procedure 105, the sentence pattern components will be shuffled to become a recombined sentence pattern.

If the problem style is the advanced phrase sentence practice, advanced word sentence practice, advanced prototype sentence practice, or advanced ultimate sentence practice, then in addition to shuffling the sentence pattern in the recombination procedure 105, some interference elements will be added into the recombined sentence pattern in order the increase the problem difficulty. In the current embodiment, the interference elements are words or phrases that are not in the prototype sentence pattern component table 301 but are often misused or mixed with the words or phrases therein. For example, in the easy mistake column 203 of the sentence pattern data structure 2, the article “the” is likely to mix with the indefinite article “a” and “an”. In this situation, “a” or “an” can be read in from the interference element table 302 in FIG. 3 and added into the recombined sentence pattern.

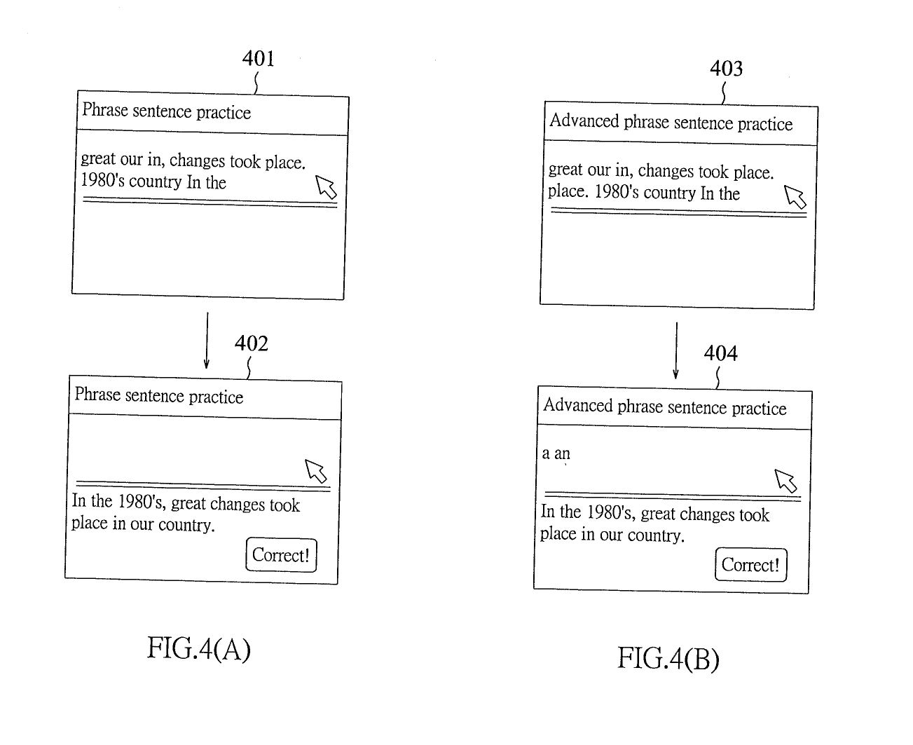

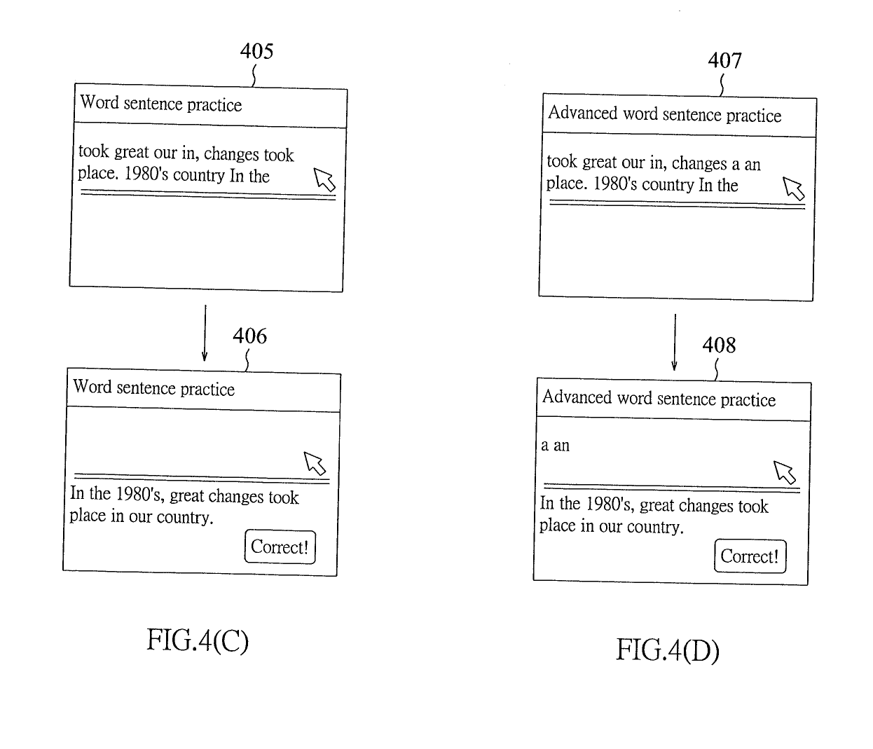

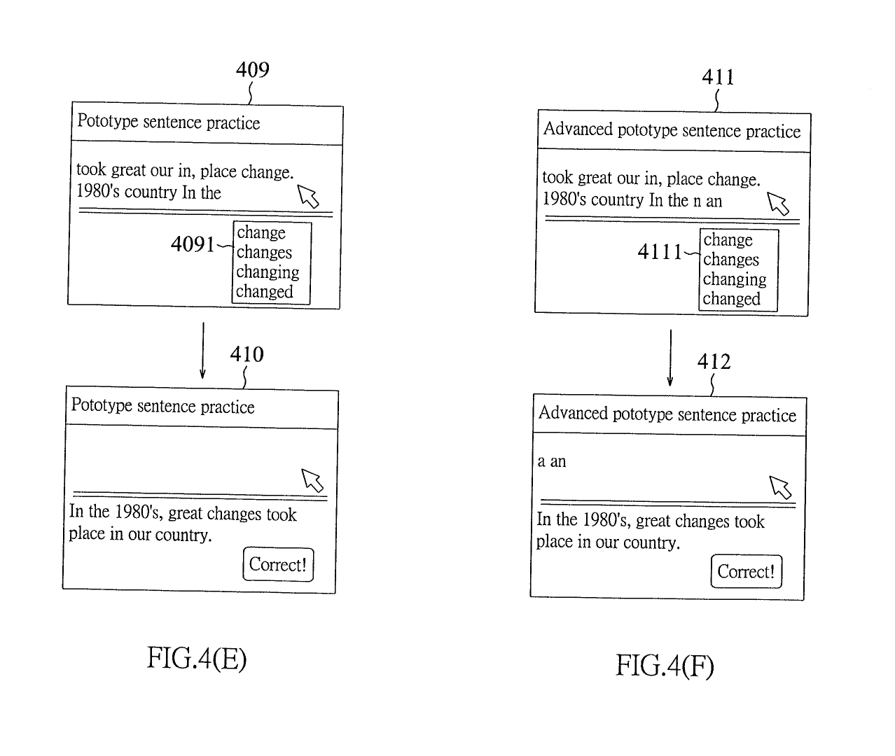

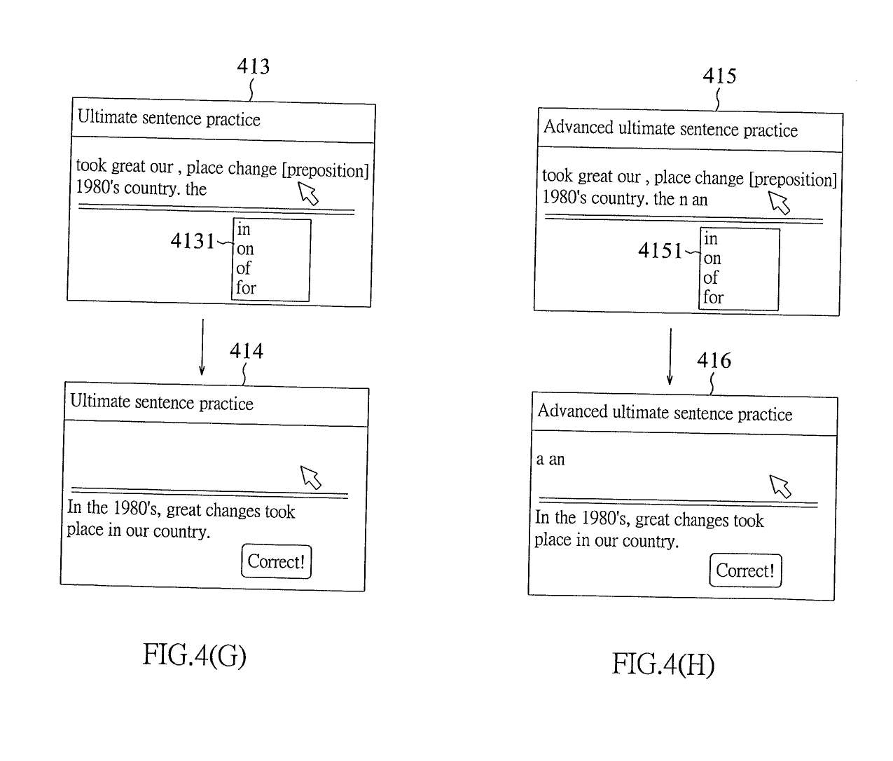

The problem output procedure 106 outputs the recombined sentence pattern generated in the sentence recombination procedure 105 to the learner. The input accepting procedure 107 accepts the input from the learner. In the current embodiment, the recombined sentence is display on a monitor for the learner to select each sentence pattern component and form a complete sentence pattern. With reference to FIG. 4(A), a window 401 shows the situation when displaying a recombined sentence pattern to the learner when the problem style is the phrase sentence practice. Another window 402 shows the situation where a complete input sentence is formed after the learner selects in order each sentence pattern component when the problem style is the phrase sentence practice. It should be noted that the learner could enter his answer in various other ways. For example, he can enter the learner input sentence directly through a keyboard or by a voice recognition technique.

With reference to FIG. 4(B), a window 403 shows the situation of displaying a recombined sentence pattern to the learner when the problem style is the advanced phrase sentence practice. Another window 404 shows the situation where a complete input sentence is formed after the learner selects, in order, each sentence pattern component when the problem style is the phrase sentence practice. In the advanced phrase sentence practice problem style, the phrase “took place” is considered as a sentence pattern component as in the phrase sentence practice problem style. The difference, however, is in that there are interference elements “a” and “an” in the advanced phrase sentence practice problem style. Since the learner should not choose those interference elements when forming a learner input sentence, therefore the two interference elements are still left at the top of the window 404.

With reference to FIGS. 4(C) and 4(D), the situations of displaying problems and of getting the learner's input are shown when the problem styles are the word sentence practice and the advanced word sentence practice, respectively. The difference between these styles and the previously mentioned phrase sentence practice and advanced phrase sentence practice is in that the phrases are separated into individual words. For example, the phrase “took place” is separated into “took” and “place” in windows 405 and 407. The learner is supposed to enter the same sentence as in the windows 402 and 404 without being influenced by the fact that the phrase is decomposed into individual words.

If the recombined sentence pattern has sentence pattern components that are attached with the prototype tags, then a prototype derivative providing procedure 108 and a prototype derivative selection procedure 109 are processed to provide the prototype derivatives to the learner and allow the learner to select the prototype derivatives. With reference to FIGS. 4(E) and 4(F), when the problem style is the prototype sentence practice or the advanced prototype sentence practice, in addition to decomposing phrases into individual words, the word “changes” with the prototype tag is changed back to its prototype “change”. When the learner selects “change”, the prototype derivative providing procedure 108 and the prototype derivative selection procedure 109 retrieve the prototype derivative “changes” and provide it to the learner in windows 4091 and 4111. The learner can pick the correct type he wants and form a complete learner input sentence.

The difference between the prototype sentence practice and the advanced prototype sentence practice is in that interference elements are added into the recombined sentence pattern in the later problem style.

If the sentence pattern components of the recombined sentence pattern have those attached with attribute tags, then an attribute derivative providing procedure 110 and an attribute derivative selection procedure 111 are processed to provide attribute derivatives to the learner and to allow the learner to select an attribute derivative. With reference to FIGS. 4(G) and 4(H), when the problem style is the ultimate sentence practice or the advanced ultimate sentence practice, in addition to decomposing phrases into individual words, the sentence pattern component “in” with the attribute tag is changed to the attribute type “preposition”. When the learner selects the “preposition”, the attribute derivative providing procedure 110 and the attribute derivative selection procedure 111 retrieve the attribute derivatives of the “preposition” from an attribute derivative table 304. They are given to the learner in windows 4131 and 4151. The learner can select the one he thinks is correct from the provided attribute derivatives and form a complete learner input sentence.

The difference between the ultimate sentence practice and the advanced ultimate sentence practice is in that interference elements are added into the recombined sentence pattern in the later problem style.

After the learner enters a learner input sentence, a comparison procedure 112 is processed to compare the learner input sentence and the original sentence. IF they agree, then an agreement message is displayed to the learner in the result output procedure 113. For example, in the eight problem styles shown in FIGS. 3(A) through 3(H), If the learner input sentence agrees with the original sentence, then a “CORRECT” message is displayed so that the learner knows that he has a correct answer.

After the result output procedure 113, if the problem giving process is not yet finished, the procedure goes back to the problem style determination procedure 101 to determine the next problem style. If no further problem is requested or provided, the disclosed method 1 finishes.

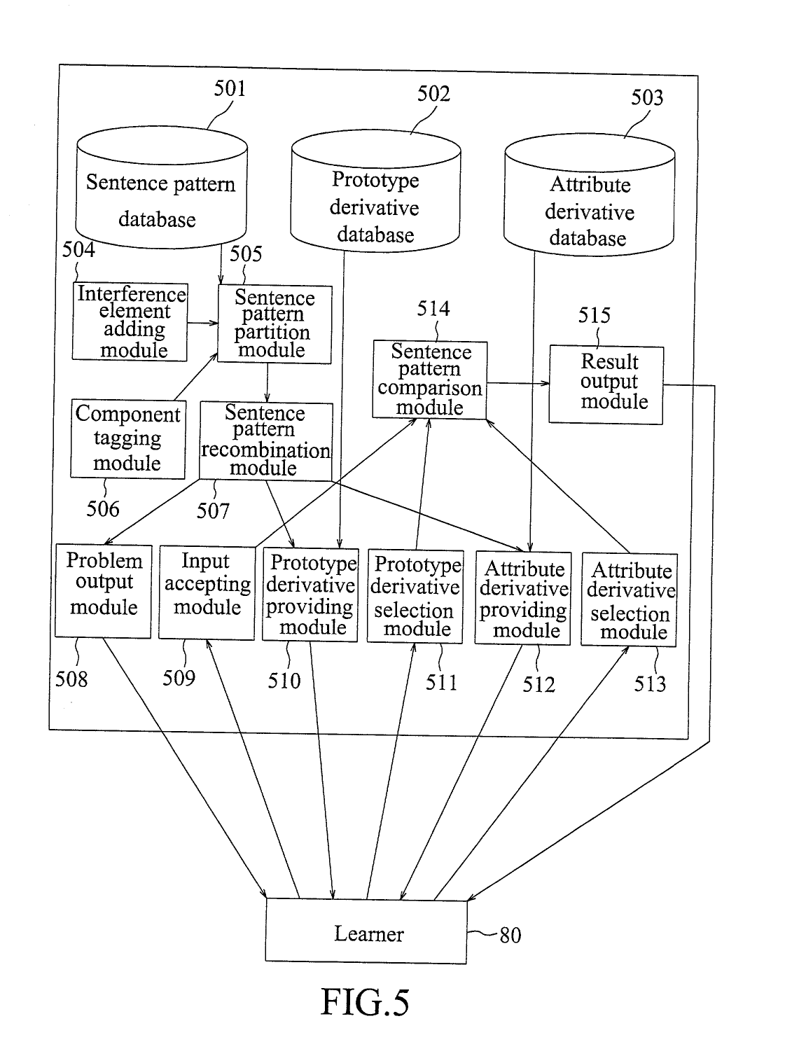

The disclosed method 1 can be implemented using computer or network technologies. With reference to FIG. 5, the disclosed system 2 according to a preferred embodiment of the invention is implemented on a network server. A sentence pattern database 501 stores several sentence pattern data structure 2 as in FIG. 2. A prototype derivative 502 stores several prototype derivative tables 305 as shown in FIG. 3. An attribute derivative database 503 stores the attribute derivative table 304 as shown in FIG. 3. Each database can be stored in any computer readable storage device or recording medium, such as a hard disk drive (HDD), memory, disks, or optical disks. In the current embodiment, each database is stored in the network server HDD.

A sentence partition module 505 decomposes the prototype sentence pattern into several sentence pattern components. A sentence recombination module 507 shuffles the sentence pattern components to obtain a recombined sentence pattern. An interference element adding module 504 adds at least one interference element in the recombined sentence pattern. A component tagging module 506 attaches normal tags, prototype tags or attribute tags to the sentence pattern components. The above modules can be program modules stored in a computer readable storage device or recording medium so that the network server can implement the functions after reading them in.

A problem output module 508 displays the recombined sentence pattern on a computer monitor for a learner 80 through the Internet. Afterwards, the input accepting module 509 receives the learner's input. The learner 80 can directly click, in order, the sentence pattern components on the screen using a mouse. He can also use a conventional keyboard or the voice input method to enter the learner input sentence. The entered sentence is then transmitted to the network server. If a sentence pattern component is attached with a prototype tag, a prototype derivative providing module 510 provides prototype derivatives of the sentence pattern component from the prototype derivative database 502 and displays another window on the monitor for the learner 80 to select. A prototype derivative selection module 511 accepts the prototype derivatives selected by the learner 80 through a mouse or a keyboard. If a sentence pattern component is attached with an attribute tag, then an attribute derivative providing module 512 then provides the attribute derivatives of the sentence pattern component and displays another window on the monitor for the learner 80 to select. An attribute derivative selection module 513 accepts the attribute derivatives selected by the learner 80 through a mouse or a keyboard.

After the learner 80 finishes his input, a sentence comparison module 514 compares the prototype sentence pattern with the learner input sentence to obtain a comparison result. A result output module 515 then displays this comparison result on a computer monitor, telling the learner 80 whether his input is correct.

It should be noted that in the disclosed system, each module could be stored in any storage device or recording medium in the form of program modules so that the functions can be implemented after the computer device reads them in. Moreover, any person skilled in the art can readily make each module into a chip module and put them into an electronic dictionary or a personal digital assistant (PDA).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of making problems for a person to learn a foreign language through sentence practice, which comprises:
a problem style determination procedure to determine a problem style;
a sentence pattern reading in procedure to read in a prototype sentence pattern from a computer readable sentence pattern database;
a sentence pattern partition procedure to separate the prototype sentence pattern into a plurality of sentence pattern components according to the problem style;
a sentence pattern recombination procedure to shuffle the sentence pattern components to obtain a recombined sentence pattern according to the problem style;
a problem output procedure to output the recombined sentence pattern to a learner;
an input accepting procedure to receive the input of the learner;
a comparison procedure, wherein a comparison module is used to compare the prototype sentence pattern with the learner input sentence so as to obtain a comparison result; and
a result output procedure to output the comparison result to the learner.

2. The method of claim 1, wherein the learner determines the problem style in the problem style determination procedure.

3. The method of claim 1, wherein the problem style is a phrase sentence practice in which the sentence pattern components include phrases and words and the sentence partition procedure keeps the phrases intact.

4. The method of claim 1, wherein the problem style is a word sentence practice in which the sentence pattern components include phrases and words and the sentence partition procedure further decomposes the phrases into individual words.

5. The method of claim 1, wherein the problem style is an advanced phrase sentence practice in which the sentence pattern components include phrases and words and the sentence partition procedure keeps the phrases intact but adds in the recombined sentence pattern at least one interference element, the interference element referring to components that are related to the sentence pattern components of the prototype sentence pattern but do not exist therein.

6. The method of claim 1, wherein the problem style is an advanced word sentence practice in which the sentence pattern components include phrases and words and the sentence partition procedure further decomposes the phrases into individual words and adds in the recombined sentence pattern at least one interference element, the interference element referring to components that are related to the sentence pattern components of the prototype sentence pattern but do not exist therein.

7. The method of claim 1, further comprising:
a component tagging procedure, which attaches a tag to each of the sentence pattern components.

8. The method of claim 7, wherein the tag is a normal tag.

9. The method of claim 7, wherein the tag is a prototype tag, and the method further comprises:
a prototype derivative providing procedure to provide the prototype derivatives of the sentence pattern components attached with the prototype tags to the learner; and
a prototype derivative selection procedure to receives the prototype derivatives selected by the learner.

10. The method of claim 9, wherein the problem style is a prototype sentence practice in which the sentence pattern components include phrases and words and the sentence pattern partition procedure further decomposes the phrases into individual words.

11. The method of claim 9, wherein the problem style is an advanced prototype sentence practice in which the sentence pattern components include phrases and words, the sentence pattern partition procedure further decomposes the phrases into individual words and the sentence pattern recombination procedure adds into the recombined sentence pattern at least one interference element, the interference element referring to components that are related to the sentence pattern components of the prototype sentence pattern but do not exist therein.

12. The method of claim 7, wherein the tag is an attribute tag and the method further comprises:
an attribute derivative providing procedure to provide the attribute derivatives of the sentence pattern components attached with the attribute tags to the learner; and
an attribute derivative selection procedure to receives the attribute derivatives selected by the learner.

13. The method of claim 12, wherein the problem style is a ultimate sentence practice in which the sentence pattern components include phrases and words and the sentence pattern partition procedure further decomposes the phrases into individual words.

14. The method of claim 12, wherein the problem style is an advanced ultimate sentence practice in which the sentence pattern components include phrases and words, the sentence pattern partition procedure further decomposes the phrases into individual words and the sentence pattern recombination procedure adds into the recombined sentence pattern at least one interference element, the interference element referring to components that are related to the sentence pattern components of the prototype sentence pattern but do not exist therein.

15. A system for making problems for a person to learn a foreign language through sentence practices, which comprises:
a sentence pattern database, which stores a plurality of sentence pattern data structures, each of which storing a prototype sentence pattern;
a sentence pattern partition module to separate the prototype sentence pattern into a plurality of sentence pattern components;
a sentence pattern recombination module to shuffle the sentence pattern components to obtain a recombined sentence pattern;
a problem output module to output the recombined sentence pattern to a learner according to the problem style he enters;
an input accepting module to receive the learner's input;
a comparison module, which compares the prototype sentence pattern with the learner input sentence so as to obtain a comparison result; and
a result output module to output the comparison result to the learner.

16. The system of claim 15, further comprising an interference element adding module, which adds into the recombined sentence pattern at least one interference element, the interference element referring to components that are related to the sentence pattern components of the prototype sentence pattern but do not exist therein.

17. The system of claim 15, wherein the problem style is a phrase sentence practice in which the sentence pattern components include phrases and words and the sentence pattern partition module keeps the phrases intact.

18. He system of claim 15, wherein the problem style is a word sentence practice in which the sentence pattern components include phrases and words and the sentence pattern partition module further decomposes the phrases into individual words.

19. The system of claim 15, wherein the problem style is an advanced phrase sentence practice in which the sentence pattern components include phrases and words, the sentence pattern partition module keeps the phrases intact, and the sentence pattern recombination module further adds into the recombined sentence pattern at least one interference element, the interference element referring to components that are related to the sentence pattern components of the prototype sentence pattern but do not exist therein.

20. The system of claim 15, wherein the problem style is an advanced word sentence practice in which the sentence pattern components include phrases and words, the sentence pattern partition module decomposes the phrases into individual words, and the sentence pattern recombination module further adds into the recombined sentence pattern at least one interference element, the interference element referring to components that are related to the sentence pattern components of the prototype sentence pattern but do not exist therein.

21. The system of claim 15, further comprising a component tagging module, which attaches a tag to each of the sentence pattern components according to the problem style.

22. The system of claim 21, wherein the tag is a normal tag.

23. The system of claim 21, wherein the tag is a prototype tag and the system further comprises:
a prototype derivative providing module, which provides the prototype derivatives of the sentence pattern components with the prototype tags from a computer readable prototype derivative database; and
a prototype derivative selection module, which receives the prototype derivatives selected by the learner.

24. The system of claim 23, wherein the problem style is a prototype sentence practice in which the sentence pattern components include phrases and words and the sentence pattern partition module further decomposes the phrases into individual words.

25. The system of claim 23, wherein the problem style is an advanced prototype sentence practice in which the sentence pattern components include phrases and words, the sentence pattern partition module further decomposes the phrases into individual words, and the sentence pattern recombination module adds into the recombined sentence pattern at least one interference element, the interference element referring to components that are related to the sentence pattern components of the prototype sentence pattern but do not exist therein.

26. The system of claim 21, wherein the tag is an attribute tag and the method further comprises:
an attribute derivative providing module to provide the attribute derivatives of the sentence pattern components attached with the attribute tags to the learner; and
an attribute derivative selection module to receives the attribute derivatives selected by the learner.

27. The system of claim 26, wherein the problem style is a ultimate sentence practice in which the sentence pattern components include phrases and words and the sentence pattern partition module further decomposes the phrases into individual words.

28. The system of claim 26, wherein the problem style is an advanced ultimate sentence practice in which the sentence pattern components include phrases and words, the sentence pattern partition module further decomposes the phrases into individual words and the sentence pattern recombination module adds into the recombined sentence pattern at least one interference element, the interference element referring to components that are related to the sentence pattern components of the prototype sentence pattern but do not exist therein.
